(19) United States
(12) Patent Application Publication
(10) Pub. No.: US 2010/0147174 A1
(43) Pub. Date: Jun. 17, 2010

(54) DEVICE FOR MAKING DAMPING SOLUTION BY REDUCING SURFACE TENSION OF WATER USED FOR OFFSET PRINTING METHOD, WHICH IS LITHOGRAPHIC PRINTING METHOD

(76) Inventor: Mitsuru Takei, Tokyo (JP)

Correspondence Address: JORDAN AND HAMBURG LLP, 122 EAST 42ND STREET, SUITE 4000, NEW YORK, NY, 10168, US

(21) Appl. No.: 11/989,805

(22) PCT Filed: Dec. 14, 2007
(86) PCT No.: PCT/JP2007/074167

§ 371 Date: Sep. 25, 2008

(30) Foreign Application Priority Data
Feb. 5, 2007 (JP) 2007-054818

(51) Int. Cl. B41F 3/34; C02F 9/12; C02F 1/20

(52) U.S. Cl. 101/492; 210/199; 210/194; 210/188

(57) ABSTRACT

A water treatment system for supplying dampening water for wet offset printing comprises a flow path through which water can pass; a magnetic treatment device for magnetically treating the water passing through the flow path; and a photocatalytic device for photocatalytically treating the water passing through the flow path.

### BACKGROUND OF THE INVENTION

The present invention relates to devices for reducing surface tension of water used for offset printing, or so-called planographic printing, to make dampening water, and in particular, to devices for reducing surface tension of water used for wet (water-using) offset printing, or so-called planographic printing, to provide dampening water, that are suitable for commercial printing of posters, calendars, catalogs, flyers, magazines, wrapping papers, maps, labels and so on and minimizes environmental pollution.

Printing plates used for offset printing, or so-called planographic printing, are formed of lipophilic imaging areas corresponding to letters and patterns and hydrophilic non-imaging areas corresponding to blanks. Oil-based ink is deposited on the lipophilic imaging areas while water is deposited on the hydrophilic non-imaging areas so that mutual repulsive action between the ink and the water may be used to print the imaging areas on the paper surface.

Devices for reducing surface tension of water used for offset printing, or so-called planographic printing, to make dampening water first apply water to the printing plates with water applicator rollers and then deposit the oil-based ink on the imaging areas of the plates. The devices then transfer the oil-based ink from the plates to a blanket and pass a printing paper between the blanket and an impression cylinder to thereby accomplish printing.

Printing papers are coated with calcium carbonate and the like in order to enhance whiteness. When the acidity of water is increased, the calcium carbonate and the like on the paper surface will dissolve into the water and will adhere to circulation pipe systems and roller systems or contaminate circulation tanks, causing troubles in printing.

For performing offset printing, so-called planographic printing, an organic solvent, such as isopropyl alcohol (hereinafter, IPA) is conventionally added to water used in order to reduce surface tension of dampening water. Also, an additive, called etch solution, is mixed in the water for surface leveling, rust prevention, pH adjustment and the like.

FIG. 11 is a schematic illustration of a circulation type water supply installation in conventional offset printing, or so-called planographic printing, wherein 100 denotes a circulation tank, 101 denotes a water feed pump, 102 denotes a printing machine, 103 denotes a recovery pipe for recovering return water to the circulation tank 100, 104 denotes a filter and 105 denotes a recovery pipe.

IPA and etch solution or the like are, where appropriate, mixed in the circulation tank 100 to be agitated by a mixer 106, while water W is repeatedly used in the circuit described above in a continuous manner. IPA as described above is, however, a hazardous material as designated under Fire Defense Law and also an object to be regulated under Ordinance on Prevention of Organic Solvent Poisoning, Industrial Safety and Health Law. It is not only harmful to humans, but can be a cause of environmental pollution as well. In addition, etch solutions are relatively expensive and use of them in large amount can lead to an increase in printing cost. In other words, the water W to be conventionally used as dampening water (refer to FIG. 5) needs to be mixed with IPA or an etch solution, increasing printing cost. Also, for discharging out of installations, devices or the like for purification and for processing industrial wastes are needed in order to reduce COD, BOD and the like to or below regulation values, therefore, disadvantageously raising running cost.

Inventions, such as Japanese Unexamined Patent Publication No. 1998-337975, Japanese Unexamined Patent Publication No. 1994-206391, Japanese Unexamined Patent Publication No. 1993-112085, etc. have been proposed and disclosed, wherein water-soluble, high-boiling solvents, such as ethylene glycol ether and propylene glycol ether, are added to etch solutions as alternative additives for IPA and the etch solutions described above.

In the patent publications listed above, one solution is expected to provide both the function of surface leveling, rust prevention and pH adjustment and the function of surface tension reduction. On the site of use, however, amounts required for the function of surface leveling, rust prevention and pH adjustment and the function of surface tension reduction do not necessarily correspond due to the differences in water supply systems, water qualities and environments (humidity, temperature) and the like of printing machines. Coping with that with one solution necessitates cumbersome creation of complex management criteria and causes troubles in printing. Therefore, such alternative additives for IPA and etch solutions as described above are not unsuited for practical applications, but may not represent specific measures for IPA reduction.

Patent Reference 1: Japanese Unexamined Patent Publication No. 1998-337975

Patent Reference 2: Japanese Unexamined Patent Publication No. 1994-206391

Patent Reference 3: Japanese Unexamined Patent Publication No. 1993-112085

### SUMMARY OF THE INVENTION

It is a first object of the present invention to reduce surface tension of water with no use at all of IPA, etch solutions or other chemicals and to decompose organic matters and living organisms such as microorganisms contained in the water to solve environmental pollution problems and make industrial waste disposal unnecessary. It is a second object of the present invention to provide devices for reducing surface tension of water used for offset printing, or so-called planographic printing, to make dampening water, that enable extended use of each component of a water circulation system and easily accomplish quality printing.

In consideration of various problems associated with the prior art described above, in order to solve the problems described above, the present inventors, with a focus on photocatalyst rapidly growing at home and abroad in recent years as an environmental purification technology for decomposition of hazardous materials, antifouling and the like, have conducted an intensive research for exploitation of the principle of magnetofluid activity, a totally unexpected field from the printing industry, to complete the present invention.

Means for solving the problems are inventions as defined in CLAIMS of this application and specific means for solving will be described below.

In order to eliminate misunderstanding in interpretation of key terms used in CLAIMS, DESCRIPTION and elsewhere, such terms will now be defined with respect to their meanings.

Photocatalyst refers to a substance that acts as a catalyst by absorbing light. Various metal oxides, such as titanium oxide (TiO₂) and zinc oxide (ZnO₂) are mentioned as metals having photocatalytic functions. Currently, however, titanium oxide (TiO₂) has only been practically applied. The functions of photocatalysts are to generate active substances from oxygen and water and to decompose and detoxicate organic matters (including printing inks), odoriferous substances, bacteria, viruses and the like. Characteristically, photocatalysts will function semipermanently.

Principle of magnetofluid activity refers generically to the principle of magnetohydrodynamic (MHD) generation, Fleming's law and Lorentz force. The principle of MHD generation refers to the generation principle for converting all the energy possessed by a fluid to electricity on the basis of Faraday's law of electromagnetic induction, in which electronic excitation action occurs when an electrically conductive fluid flows perpendicularly across a magnetic field.

Fleming's law states that the principle of MHD generation has a law of direction, in which, when an electrically conductive substance flows perpendicularly across a magnetic field, the first finger of the right hand represents the direction of the magnetic field and the thumb represents the direction of motion of the conductor, while the induced current will flow along the direction of the second finger oriented at right angles both to the thumb and the first finger.

Lorentz force: there are a number of chargeable substances in water, typical examples of which include ions of calcium, potassium, magnesium and the like. Lorentz force refers to the force exerted on a charged substance when the substance moves across a magnetic field. The Lorentz force is exerted perpendicularly to the direction of motion to curve positively and negatively charged substances along separate trajectories. While being curved in trajectories, the molecules of water will break away from the bond, reducing the size of the cluster.

Hydration refers to decomposition or neutralization of bacterial cells by ultraviolet radiation.

Dimerization refers to termination of the mechanism of replicating DNA molecules by irradiation of ultraviolet radiation.

Spore refers to a cystoid spore of a hypha.

Water treatment system for supplying dampening water means a system externally attached to a circulation tank of a dampening water supply section of a wet offset printing system and also a system incorporated integrally into a dampening water supply section of a wet offset printing system.

System is a concept encompassing devices.

Dot gain means a gain in thickness of a halftone dot on a paper surface in relation to a halftone dot of a printing plate.

The present invention (1) is a water treatment system for supplying dampening water (for example, water treatment system for supplying dampening water S) for wet (water using) offset printing, comprising:

a flow path through which water can pass (for example, circulation pipe system Pa);

a magnetic treatment device (for example, magnetic treatment device 5) for magnetically treating the water passing through the flow path; and

a photocatalytic device (for example, photocatalytic device 3) for photocatalytically treating the water passing through the flow path.

The present invention (2) is the water treatment system according to the invention (1), wherein the flow path is a circuit (for example, a circulation pipe system Pa) into which water from a circulation tank (for example, circulation tank 1) of the wet offset printing system can be introduced and through which the introduced water can be returned back into the circulation tank.

The present invention (3) is the water treatment system according to the invention (1) or (2) wherein the magnetic treatment devices are disposed before and behind the photocatalytic device.

The present invention (4) is the water treatment system according to any one of the inventions (1) to (3) wherein the photocatalytic device includes a fiber formed body composed of fibers containing a photocatalyst (for example, photocatalytic nonwoven fabric 3d) and an irradiation lamp for irradiating the fiber formed body with light (for example, ultraviolet irradiation lamp 3b).

The present invention (5) is the water treatment system according to the invention (4) wherein the photocatalytic device is made of mutually isolated, multiple fiber formed bodies in a stacked arrangement along the flow path (for example, photocatalytic device 3).

The present invention (6) is the water treatment system according to any one of the inventions (1) to (5) further comprising a gas-water separator (for example, gas-water separator 11) for separating gases from the water passing through the flow path.

The present invention (7) is a wet offset printing system incorporating the water treatment system according to any one of the inventions (1) to (6).

The present invention (8) is a method for wet offset printing, comprising a dampening step for supplying dampening water to a printing plate, an inking step for extracting ink from an ink supply section and supplying the ink to the printing plate, a step for transferring the ink deposited on the printing plate to a blanket and a step for transferring the transferred ink from the blanket to a paper,

wherein magnetically and photocatalytically treated water, containing no isopropyl alcohol or etch solutions, is used as the dampening water.

The present invention (9) is the method for printing according to the invention (8) comprising the step of obtaining the dampening water by using the water treatment system according to any one of the inventions (1) to (6).

The present invention (10) is a print printed by wet offset printing, wherein ink on the print and the paper surface contain no isopropyl alcohol or etch solution-derived components and the dot gain of the ink on the print is from 2 to 5%.

The present invention (11) is the print according to the invention (10) wherein the differences in dot gain of halftone dots formed by cyan, magenta, yellow and black inks are from 0 to 3%.

The present invention (12) is a print printed by wet offset printing, wherein ink on the print and the paper surface contain no isopropyl alcohol or etch solution-derived components, obtained by the method for printing according to the invention (8) or (9).

Based on the water treatment system for supplying dampening water according to the present invention, the following effects have been achieved. According to the invention (1), the surface tension of the water can remarkably be reduced to make modified dampening water suitable for offset printing by the synergistic effect of magnetic and photocatalytic treatments, with no use at all of chemicals, i.e., IPA, etch solutions or alternative chemical additives. Also, since the photocatalytic device decomposes organic matters and living organisms such as microorganisms contained in the water, the first object of the present invention to solve environmental pollution problems and eliminate the cost for industrial waste disposal has been achieved. Further, through practical application of the present invention, troubles associated with calcium carbonate on printing machines, dampening water administration and so on can be eliminated so that normal printing operation may continuously be carried out, enabling extended use of each component of the circulation device. Also, excessive emulsification of printing ink may be prevented and the ink may be reduced in film thickness to accelerate drying and facilitate posttreatment. Thereby, the second object has also been achieved. Also, the magnetic treatment device and the photocatalytic device for reducing surface tension can be fabricated as a single unit and conveniently incorporated into an existing tank or the like regardless of reservoir capacity.

Also, since the magnetic and photocatalytic treatments are carried out in the water treatment system for supplying dampening water, the circulation process is repeatedly carried out in a continuous manner in which the water is fed to the circulation tank as having reduced surface tension, recovered by way of the water supply device and the printing machine back to the circulation tank and again recovered through the water pump, the photocatalytic device, the magnetic treatment device, the circulation tank, the water supply device, the printing machine and the filter back to the circulation tank. With the use of the magnetic treatment device in combination with the photocatalytic device, the surface tension of the water, 74 dyne/cm (mN/m), has successfully been reduced by 52 to 54% (to 35.2 to 34.0 dyne/cm) [with the magnetic treatment alone, by approximately 12 to 18% (to 65.2 to 60.7 dyne/cm)]. By reducing the surface tension of the water, the following effects have been achieved. Specifically, (1) the printing ink was not unnecessarily emulsified, with its adherence improved. (2) The whiteness of the paper surface was improved. (3) The ink was improved in balance, opening the possibility for three primary-color printing. (4) The film thickness of the printing ink was reduced, transferability to the blanket was improved and the drying time for the printed paper and the printing ink was shortened. (5) Since no chemicals need to be added to the water, the rubber rollers are less prone to chemical modification, enabling extended use. (6) Since no influence of chemicals is exerted on the printing plate, the printing plate has an increased print resistance. (7) The pH of the water is neutralized (around pH 7) so that calcium carbonate or the like on the paper surface will not dissolve, avoiding the inflow of calcium carbonate or the like into the circulation tank, circulation pipes and the like, and simultaneously printing failures due to calcium carbonate deposited on the printing roller or the printing plate may totally be eliminated. (8) Pollution of water caused by printing ink and other chemicals is eliminated so that restrictions on waste water treatment for COD, BOD and the like may be lifted. (9) Restrictions by Fire Defense Law and Ordinance on Prevention of Organic Solvent Poisoning, Industrial Safety and Health Law described above are no longer applied. (10) Cleaning of piping, such as the circulation pipe, inside the printing machine, can be carried out, so that cleaning inside the pipes may be dispensed with.

According to the invention (2), since the magnetic and photocatalytic treatments can repeatedly be carried out by circulation of the water, such an effect is obtained that process water stable in quality with sufficiently reduced surface tension may be provided to the printing system.

According to the invention (3), the magnetic treatment devices are disposed before and behind the photocatalytic device. The magnetic treatment device disposed behind the photocatalytic device functions similarly to the one mentioned above. On the other hand, the magnetic treatment device disposed before the photocatalytic device is provided for efficient photocatalytic treatment by the photocatalytic device. Photocatalytic treatment can efficiently be carried out by the treatment by the magnetic treatment device. In comparison with the invention according to the invention (1) or (2), the water treatment system for supplying dampening water having the magnetic treatment devices disposed before and behind the photocatalytic device according to the invention (3) has the effect of improving print accuracy.

Then, according to the invention (4), by providing the fiber formed body composed of fibers containing a photocatalyst in the photocatalytic device, the area of contact between the passing water and the photocatalyst is increased, so that the photocatalytic treatment can more efficiently be carried out.

According to the invention (5), since the photocatalytic device is made of mutually isolated, multiple fiber formed bodies in a stacked arrangement along the flow path of water, the photocatalyst of each fiber molded form efficiently receives light from the irradiation lamp to provide catalytic action, so that the photocatalytic treatment can more efficiently be carried out.

According to the invention (6), since the gas-water separator is further included for separating gases from the water passing through the circuit, air bubbles in the water are reduced, so that the magnetic treatment can more efficiently be carried out.

According to the invention (7), such an effect is obtained that a wet offset printing system enabling the use of water containing no isopropyl alcohol, etch solutions or the like (for example, tap water) as dampening water may be provided.

According to the invention (8), magnetically and photocatalytically treated water, containing no isopropyl alcohol or etch solutions, can be used as dampening water for offset printing. Namely, according to the invention, water (for example, tap water), to which isopropyl alcohol and etch solutions conventionally added essentially are not added, can be possibly used.

According to the invention (9), by using the water treatment system for supplying dampening water according to any one of the inventions (1) to (6), the magnetic and photocatalytic treatments may efficiently and effectively be carried out.

According to the invention (10), since no isopropyl alcohol and etch solution-derived components are contained on the print, the print having such hazardous components eliminated may be provided. Further, since the print has a dot gain of the ink on the paper surface of 2 to 5%, color reproduction of the print is improved, especially at shadows.

According to the invention (11), since the differences in dot gain of halftone dots formed by cyan, magenta, yellow and black inks are from 0 to 3%, color reproduction of the print is further improved. Dot gains are produced by ink crushed down when the ink is transferred to a print or the like. Specifically, the softness of ink on a print and the film thickness of ink are closely related with dot gain. Factors having influence on the softness of ink include emulsification of ink. Described with reference to emulsification of conventional dampening water containing additives such as isopropyl alcohol or the like and each ink described above, since additive components such as binders to contained in the ink are different and such components and isopropyl alcohol for each ink are different in hydrophilicity, emulsification of each ink and dampening water will vary. Therefore, a variation in dot gain for each ink will occur. Hydrophilicity between dampening water obtained by the magnetic and photocatalytic treatments and each ink described above will be similar. Emulsification will therefore be similar so that dot gain for each ink may be similar. In addition, the reduction in film thickness of printing ink as described above seems responsible for the reduction in dot gain.

According to the present invention (12), since the print is conveniently produced by the method for printing according to the invention (8) or (9) with the use of water containing no isopropyl alcohol or etch solutions, such an effect is obtained that the cost for management or the like of such additives is not needed, so that production cost may be reduced.

Best modes for the present invention will be described below with reference to the drawings. The technical scope of the present invention is not to be limited to the best modes. Also, it should be understood that specific matters described for one example shall be applied to other examples, unless otherwise specified.

### BRIEF DESCRIPTION OF THE DRAWINGS

FIG. 1 is a schematic illustration of a first best mode of a device for reducing surface tension of water used for wet offset printing, or so-called planographic s printing, to make dampening water according to the present invention;

FIG. 2 is a schematic illustration of a second best mode of a device for reducing surface tension of water used for offset printing, or so-called planographic printing, to make dampening water according to the present invention;

FIG. 3 is a schematic illustration of a third best mode of a device for reducing surface tension of water used for wet offset printing, or so-called planographic printing, to make dampening water according to the present invention;

FIG. 4(a) is a longitudinal section of a photocatalytic device and FIG. 4(b) is a conceptual illustration of a photocatalytic device;

FIG. 5 is a longitudinal section of another embodiment of a photocatalytic device;

FIG. 6(a) is a schematic section of one example of a magnetic treatment device and FIG. 6(b) is a section taken along the line A-A of FIG. 6(a);

FIG. 7(a) is a schematic section, partly cut away, of another example of a magnetic treatment device and FIG. 7(b) is a section taken along the line B-B of FIG. 7(a);

FIG. 8 is a schematic illustration of another example of a magnetic treatment device;

FIG. 9 is a conceptual illustration of a gas-water separator;

FIG. 10 is an illustration showing the results of surface tension measurement; and

FIG. 11 is a schematic illustration of a circulation type water supply installation in conventional wet offset printing, or so-called planographic printing.

### DETAILED DESCRIPTION OF THE INVENTION

System Configuration

The water treatment system for supplying dampening water for wet offset printing according to the best modes comprises, at least, a flow path and a magnetic treatment device and a photocatalytic device provided at the flow path. In addition to the configuration described above, the water treatment system for supplying dampening water may further comprise a gas-water separator, a filter, a flowmeter and so on. Also, the water treatment system for supplying dampening water according to the present invention may be embodied so that water used for wet offset printing is extracted from a circulation tank and the water is treated and returned back in the circulation tank or may be embodied so that the system is provided along a flow path through which water is fed from the circulation tank to soaking rollers of a printing machine.

### First Embodiment

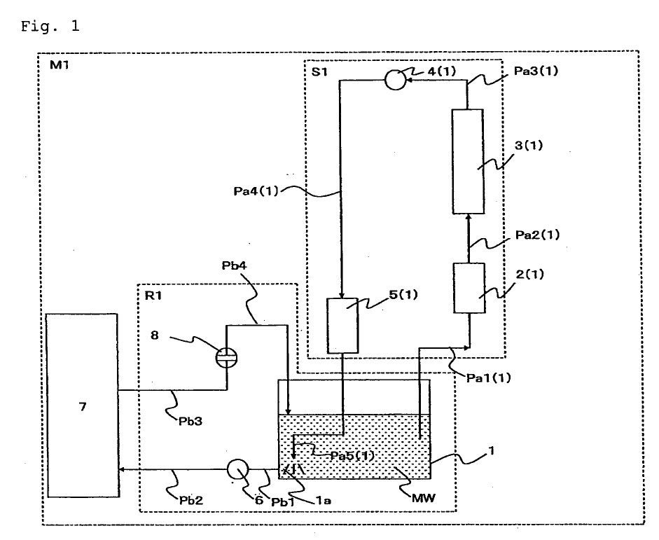

FIG. 1 shows a configuration of a first best mode of a wet offset printing system M1 according to the best mode. Here, the wet offset printing system M1 is composed of a water treatment system for supplying dampening water S1, a dampening water supply device R1 and a printing machine 7. To begin with the description of S1, the water treatment system for supplying dampening water S1 has a circulation pipe system Pa(1) [Pa1(1) to Pa5(1)] composing a circuit through which water passes, a water feed pump 2(1) connected to a circulation tank 1 through a pipe Pa1(1) for feeding water from the tank 1 to the circuit, a photocatalytic device 3(1) connected to the water feed pump 2(1) through a pipe Pa2(1) for photocatalytically treating the water passing through the circuit, a flowmeter 4(1) connected to the photocatalytic device 3(1) through a pipe Pa3(1) for measuring the flow rate of the water flowing through the circuit, a magnetic treatment device 5(1) connected to the flowmeter 4(1) through a pipe Pa4(1) and further connected to the circulation tank 1 through Pa5(1) for magnetically treating the water passing through the circuit, and the pipe Pa5(1) for connecting the magnetic treatment device 5(1) and the circulation tank 1. The flowmeter 4(1) may not be installed in consideration of the reservoir capacity of the circulation tank 1, the throughput of the water feed pump 2(1) and the like. Next, the dampening water supply device R1 to which the water treatment system for supplying dampening water S1 according to the best mode is connected in use will be described. The dampening water supply device R1 has a circulation pipe system Pb [Pb1 to Pb4] composing a circuit with the printing machine 7, a circulation tank 1 for storing water, a water feed pump 6 connected to the circulation tank 1 through Pb1 for feeding water from the circulation tank 1 to the printing machine 7 through a pipe Pb2, and a filter 8 connected to the printing machine 7 through a pipe Pb3 and also connected to the circulation tank 1 through Pb4. It is preferable that the magnetic treatment device 5(1) is disposed downstream-most within the water treatment system for supplying dampening water S1 so that the effect of the magnetically activated water may more prominently be exerted. It is also preferable that the outlet of the circulation pipe Pa5(1) is disposed near the outlet la to which the circulation tank 1(1) and the water feed pipe Pb1(1) are connected so that the magnetically and photocatalytically treated water may immediately be used as dampening water. Further, by arranging the water flow path of the magnetic treatment device 5(1) in a vertical direction (direction perpendicular to the horizontal or ground plane), the water treatment system for supplying dampening water S1 can more effectively provide magnetic treatment.

### Second Embodiment

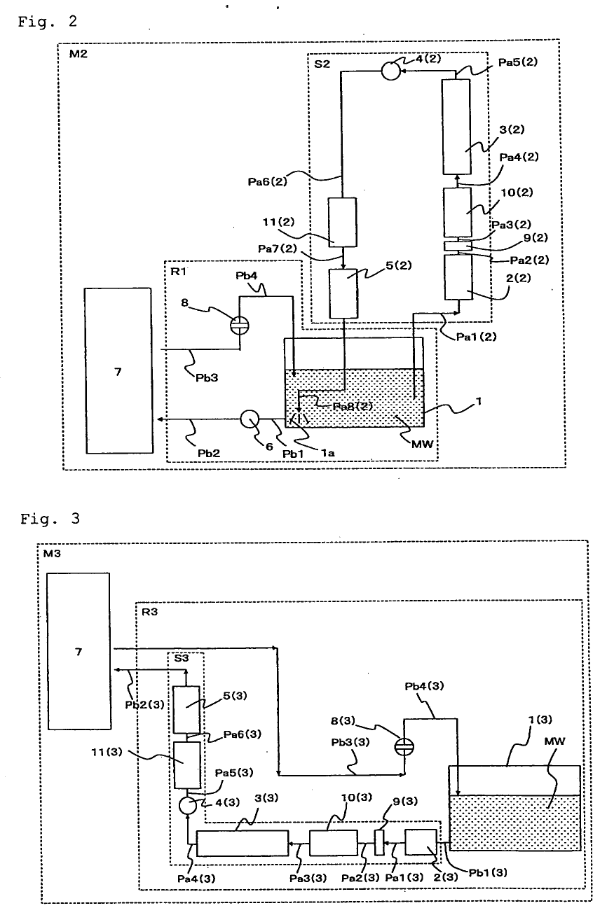

FIG. 2 shows a configuration of a second best mode of a water treatment system for supplying dampening water S2 according to the best mode. The system S2 according to the second best mode is similar in basic configuration to the first best mode, except that it has a filter 9(2) and a second magnetic treatment device 10(2) between a water feed pump 2(2) and a photocatalytic device 3(2) and further has a gas-water separator 11(2) between the photocatalytic device 3(2) and a first magnetic treatment device 5(2). Detailed structure of the gas-water separator 11(2) will subsequently be described. The first magnetic treatment device 5(2) and the second magnetic treatment device 10(2) may be similar or different in structure.

### Third Embodiment

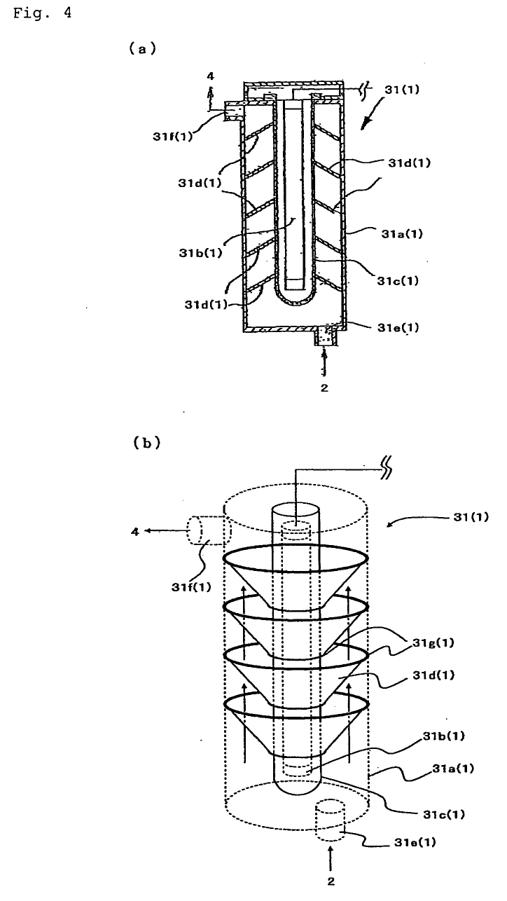

FIG. 3 shows a configuration of a third best mode of a wet offset printing system M3 according to the best mode. The water treatment systems for supplying dampening water according to the first and second best modes as mentioned above are externally attached systems which repeatedly feed water from the circulation tank 1 and then perform predetermined treatment before returning the process water back to the circulation tank 1. In contrast, the water treatment system for supplying dampening water S3 according to the third best mode is a water treatment system for supplying dampening water integral with an offset printing system, which performs photocatalytic treatment and magnetic activation treatment in the course of feeding water from a circulation tank to a printing machine.

As such, to describe this best mode in detail with reference to FIG. 3, the wet offset printing system M3 is composed of a dampening water feed device R3 and a printing machine 7, the dampening water feed device incorporating a water treatment system for supplying dampening water S3 installed between a circulation tank 1(3) and the printing machine 7. The water treatment system for supplying dampening water S3 is composed of a circulation pipe system Pa(3) [Pa1(3) to Pa6(3)] composing a flow path, a water feed pump 2(3) connected to the circulation tank 1(3) through a pipe Pb1(3), a filter 9(3) connected to the water feed pump through a pipe Pa1(3), a second magnetic treatment device 10(3) connected to the filter 9(3) through Pa2(3) for magnetically treating the water filtrated through the filter 9(3), a photocatalytic device 3(3) connected to the device 10(3) through a pipe Pa3(3) for photocatalytically treating the water passing through the circuit, a flowmeter 4(3) connected to the photocatalytic device 3(3) through a pipe Pa4(3) for measuring the flow rate of the water flowing through the circuit, a gas-water separator 11(3) connected to the flowmeter through a pipe Pa5(3) for removing gases dissolved in a liquid, and a first magnetic treatment device 5(3) connected to the gas-water separator through a pipe Pa6(3) for magnetically treating the water passing through the circuit. Also, the flowmeter 4(3) may not be installed in consideration of the reservoir capacity of the circulation tank 1(3), the throughput of the water feed pump 2(3) and the like. The dampening water feed device R3 has a circulation pipe system Pb(3) [Pb1(3) to Pb4(3)], the circulation tank 1(3), the water treatment system S3 for supplying dampening water connected to the circulation tank through a pipe Pb1(3) and further connected to the printing machine 7 through Pb2(3) and a filter 8(3) connected to the printing machine 7 through a pipe Pb3(3) and also connected to the circulation tank 1(3) through a pipe Pb4(3).

Configuration of Photocatalytic Device

Any known photocatalyst can be used as the photocatalyst to be used for the photocatalytic device 3, examples of which include, without limitation, various metal oxides, such as titanium oxide (TiO₂) and zinc oxide (ZnO₂). Examples of photocatalyst structures include silica, fibers and netted structures which support photocatalysts, fibers in which photocatalysts are incorporated and other structures. Preferable photocatalyst structures are fiber formed bodies such as woven or nonwoven fabrics of the fibers described above (for example, fibrous filters). Among them, fibers or nonwoven fabrics thereof in which photocatalysts are incorporated are particularly preferable because photocatalyst structures having photocatalysts supported or coated on the surface suffer from considerable delamination of the photocatalysts due to the use of magnetically treated water. Particularly preferable is silica-group composite oxide fiber (for example, Japanese Unexamined Patent Publication No. 2002-371436) or nonwoven fabrics thereof, containing components having photocatalytic function, such as TiO₂ or eutectic compounds thereof or those formed into substituted solid solutions by specific elements. With the use of such fiber formed body, efficiency of contact between the photocatalyst and water is increased, so that photocatalytic treatment can more efficiently be carried out and, further, delamination due to water flow is reduced in relation to that when the photocatalyst is applied on the surface of devices or the like, so that durability of the catalyst may be improved.

The photocatalytic device 3 used may be a known photocatalytic device for water treatment, without limitation. For example, it is preferably formed into a cone-shaped, formed object from the fiber formed bodies mentioned above (for example, fibrous filters) and arranged in multiple stages (stacked) in a reactor along the flow of a process fluid in a spaced manner. Further, it is preferable to provide an opening at the center of the multiple cone-shaped, formed object arranged in multiple stages and dispose an ultraviolet lamp in the opening along the direction of water flow. Specific examples of the device will be described in detail below.

FIG. 4 is a schematic illustration of a photocatalytic device 31(1) as one embodiment of the photocatalytic device 3. As shown in the longitudinal section of FIG. 4(a), the photocatalytic device 31(1) is fitted with an ultraviolet irradiation lamp 31b(1) at the center of the axial line of a cylindrical case made of stainless steel 31a(1) and has a quartz tube 31c(1) perpendicularly installed along the outer periphery of the ultraviolet irradiation lamp 31b(1). Multiple photocatalytic fiber nonwoven fabrics 31d(1) are attached in a staircase pattern from the inner peripheral wall of the cylindrical case 31a(1) to the outer peripheral wall of the quartz tube 31c(1) to form upwardly opening funnels. The photocatalytic fiber nonwoven fabrics 31d(1) are impregnated with titanium oxide (TiO₂) and are permeable to water. 31e(1) denotes an inlet for receiving water from the water feed pump 2 and 31f(1) denotes an outlet for feeding water to the flowmeter 4.

FIG. 4(b) is a conceptual illustration of the whole photocatalytic device 31(1). The photocatalytic fiber nonwoven fabrics 31d(1) in the form of a hollow truncated cone are mounted in a stacked manner about the ultraviolet irradiation lamp 31b(1) and the quartz tube 31c(1). It is preferable to provide packing 31g(1) along the outer peripheral edges and the opening edges of the photocatalytic fiber nonwoven fabrics 31d(1) in order to enhance adherence between the photocatalytic fiber nonwoven fabrics 31d(1) and the cylindrical case 31a(1) and the quartz tube 31c(1) to eliminate any gap in-between. As such, the process water can efficiently pass through the gap between the fibers of the formed body.

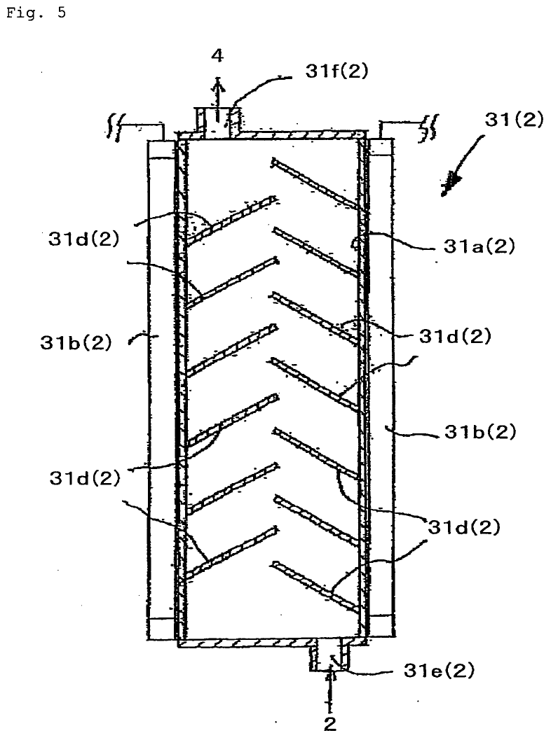

FIG. 5 shows a longitudinal section of a photocatalytic device 31(2) as another embodiment of the photocatalytic device 3. The device has multiple ultraviolet irradiation lamps 31b(2) perpendicularly installed along the outer periphery of a cylindrical case 31a(2) made of a quartz tube. Multiple photocatalytic fiber nonwoven fabrics 31d(2) are attached alternately in a staircase pattern from the lateral inner peripheral walls of the cylindrical case 31a(2) to the center of the axial line through an upward angle of approximately 30°. 31e(2) denotes an inlet for receiving water from the water feed pump 2 and 31f(2) denotes an outlet for feeding water to the flowmeter 4. Although not shown, the outer periphery of each ultraviolet irradiation lamps 31b(2) is fitted with a cylindrical protective case for ultraviolet radiation.

Configuration of Magnetic Treatment Device

The magnetic treatment device 5 according to the best mode is preferably provided with permanent magnets with different or the same poles such that they oppose each other in order to apply magnetic lines of force perpendicularly to the direction of water flow. The magnetic treatment device is not particularly limited as long as it can apply magnetic force to the water. However, magnets are preferably opposed to different or the same poles and arranged in multiple pairs in the direction of water flow, for example. Magnets to be arranged are not particularly limited, examples of which include ring-shaped magnets magnetized in a thickness direction, diameter direction, or at the two poles inside and outside, block magnets such as cubes magnets and rectangular parallelepiped magnets, magnetized in a thickness direction, lengthwise direction, or at multiple poles on one side or multiple poles on both sides and segmented magnets magnetized in a diameter direction or thickness direction.

The magnetic flux density at the center for the magnetic treatment device according to the best mode is preferably from 500 to 2000 gausses. The magnetic flux density at the center in the magnetic treatment device may however be unequal along the direction of the flow path and may only be within the range described above in at least part of the direction of the flow path.

The magnetic treatment device may further be provided with a substance irradiating far infrared radiation. It is known that synergistic effects may be obtained by irradiating far infrared radiation in addition to magnetism. Substances irradiating and absorbing far infrared radiation include ceramics of sintered alumina, calcium, zirconia and the like. Specific examples of the ceramics include sintered products having a composition of SiO₂=70 to 80%, Al₂O₃=10 to 20%, Fe₂O₃=3 to 9% and ZrO₂=0 to 5% or lower.

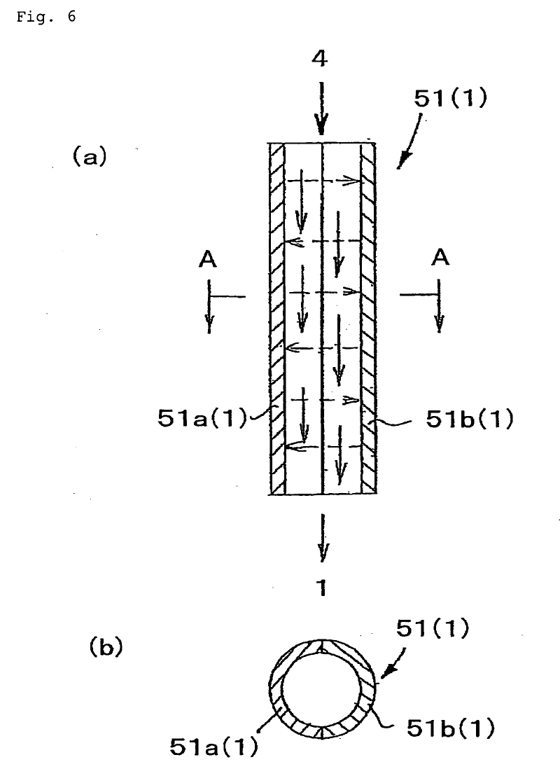

FIG. 6(a) shows a schematic cross section of a magnetic treatment device 51(1) as one example of the magnetic treatment device 5. 51a(1) and 51b(1) denote ferrite type permanent magnets and, as shown in FIG. 6(b) as a sectional view taken along the line A-A, the magnets form a cylindrical pipe. Opposed to different magnetic poles as shown in broken lines, 51a(1) and 51b(1) apply magnetic lines of force perpendicularly to the water flowing through the cylindrical pipe (solid arrows) to reduce the surface tension of the water to make dampening water MW suitable for the printing machine 7 to be fed to the circulation tank 1. Although not shown, permanent magnets with different poles may be fitted around the outer periphery of the circulation pipe Pb3(1) of the device according to the first best mode to apply magnetic lines of force perpendicularly to the water flowing through the circulation pipe Pb3(1) to reduce the surface tension of the water.

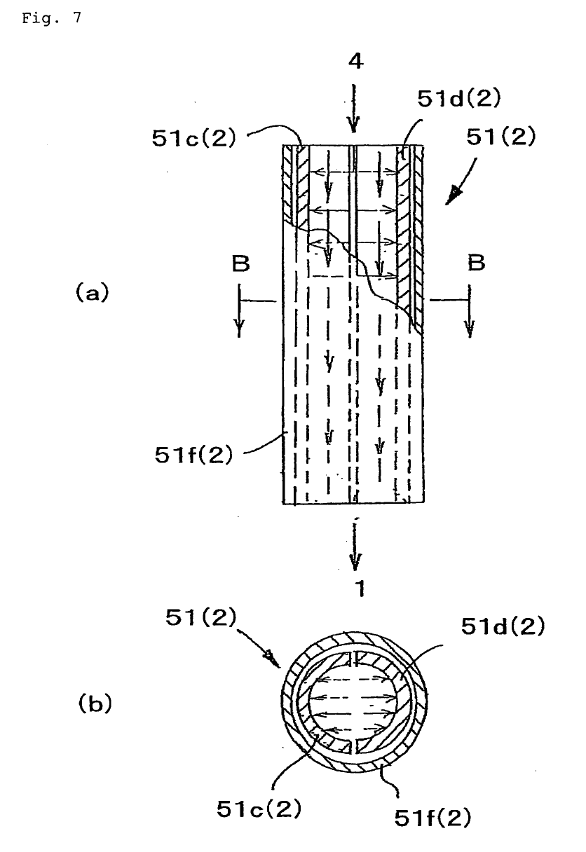

FIG. 7(a) shows a schematic cross section, partly cut away, of a magnetic treatment device 51(2) as another example of the magnetic treatment device 5. 51c(2) and 51d(2) denote ferrite type permanent magnets and, as shown in FIG. 7(b) as a sectional view taken along the line B-B, the magnets form an approximately cylindrical pipe. Opposed to the same magnetic poles, 51c(2) and 51d(2) repel each other and, as shown in parallel broken lines, apply magnetic lines of force perpendicularly to the water flowing through the cylindrical pipe (solid arrows) to reduce the surface tension of the water to make dampening water MW suitable for the printing machine 7 to be fed to the circulation tank 1. 51f(2) denotes a protective case.

FIG. 8(a) is a schematic illustration of a magnetic treatment device 51(3) as another example of the magnetic treatment device 5 described above. The magnetic treatment device 51(3) has ring-shaped magnets 51a(3) to f(3) magnetized in the thickness direction and a flow path 51g(3) formed in the direction of passage through the hollow portions of the ring-shaped magnets. The ring-shaped magnets 51a(3) to f(3) are disposed along the flow path 51g(3) in such a manner that neighboring magnets have the same poles and repel each other.

FIG. 8(b) is a schematic illustration of a magnetic treatment device 51(4) as another example of the magnetic treatment device 5. The magnetic treatment device 51(4) has block magnets 51a(4) to f(4) magnetized in the lengthwise direction, block magnets 51a′(4) to f′(4) provided in positions opposing the mentioned magnets and a flow path 51g(4) formed in a position sandwiched by the magnets 51a(4) to f(4) and the magnets 51a′(4) to f′(4). The block magnets 51a(4) to f(4) and 51a′(4) to f′(4) are disposed along the flow path 51g(4) in such a manner that neighboring magnets have the same poles and repel each other. The block magnets 51a(4) to f(4) and 51a′(4) to f′(4) oppose each other with the same poles across the flow path. Although block magnets are illustrated in this example, segmented magnets may also be used.

Optional Devices

Gas-Water Separator

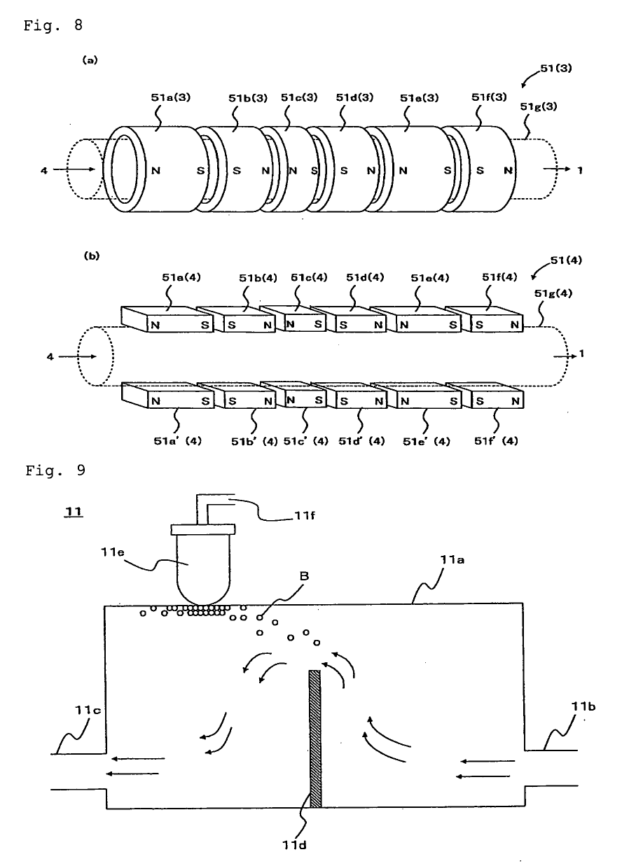

FIG. 9 is a conceptual illustration of a gas-water separator 11. The gas-water separator 11 according to the best mode comprises a casing 11a, a water inlet 11b and an outlet 11c provided at opposite ends of the casing 11a, a wall body 11d built on the bottom surface inside the casing 11a in order to impede, but not to block, the flow path between the water inlet 11b and the outlet 11c, an air bubble separator section 11e provided on the ceiling surface at a location closer to the outlet 11c than to the wall body 11d and an exhaust port 11f connected to the section.

In the gas-water separator 11, water MW introduced through the water inlet 11b is impeded by the wall body 11d off its flow path to change its flow direction upward. The water MW, with its flow direction turned upward, hits against the ceiling of the structure to further change its flow direction toward the outlet 11c. By such changes of flow directions, gases dissolved in the water will form air bubbles B and then move upward in the steam separator 11, before passing through the air bubble separator section lie to be discharged via the exhaust port 11f. By providing the gas-water separator before (preferably, immediately before) the magnetic treatment device 5, the magnetic treatment can more efficiently be performed so that print accuracy may be improved.

Filter

The filter 9 is not particularly limited as long as it is capable of removing relatively large impurities, such as milled paper, dust and powder, included in the water MW. The filter, if provided, can remove large impurities, enabling more efficient photocatalytic treatment.

Next, operation of the water treatment device for supplying dampening water for wet offset printing will be described with reference to the first best mode by way of example. The water (for example, tap water) supplied in the circulation tank 1 with a capacity of 30 L to 500 L is maintained preferably at a constant temperature of 10 to 15° C., and more preferably at a constant temperature of 8 to 12° C. The water is then fed by the water feed pump 2(1) downstream from the circulation tank 1. Here, the flow rate of the fed water is preferably from 10 to 50 L/min, more preferably from 20 to 40 L/min, and even more preferably from 27 to 35 L/min. When the flow rate of the fed water is within such ranges, the magnetic and photocatalytic treatments will effectively be performed so that print accuracy may be improved. The fed water then enters the photocatalytic device 3(1) disposed downstream the circulation tank 1. The water therein is irradiated with a shortwave ultraviolet radiation of 200 to 290 nm emitted from the ultraviolet radiation lamp 31b while passing through the photocatalytic fiber nonwoven fabric 31d in the photocatalytic device 3(1). By this treatment, organic matters and various bacteria in the water will be decomposed into carbon dioxide (CO₂) and water (H₂O) to be detoxicated. Further, when the ultraviolet radiation irradiated by the ultraviolet irradiation lamp is within the range of shortwave ultraviolet radiation mentioned above, the shortwave ultraviolet radiation will approximate the absorption band of around 260 nm which is the absorption spectrum for DNA (deoxyribonucleic acid) in bacterial cells, so that it may act on DNA in the bacterial cells and exterminate bacteria, including spores, and fungi through photochemical reactions such as hydration, dimerization and decomposition. If the printing machine is shutdown for an extended period of time, therefore, proliferation of algae, fungi and the like in the circulation tank and the like may be prevented.

The water exiting the photocatalytic device 3(1) as shown in FIG. 4 is fed by the circulation pipe system Pa(1) by way of the flowmeter 4(1) to the magnetic treatment device 5(1). As shown in FIGS. 6, 7 and 8, the water is applied with magnetic lines of force from the permanent magnets while passing through the magnetic treatment device 5(1) for reducing the surface tension and is fed to the circulation tank 1 downstream. 1a shown in FIG. 1 denotes an outlet of the circulation tank 1. As shown, the tip of the circulation pipe Pa5(1) of the magnetic treatment device 5(1) is arranged in the vicinity of the outlet 1a so that the dampening water MW having reduced surface tension may quickly be equalized in quality.

The dampening water MW in the circulation tank 1 is pumped by the water feed pump 6 by way of the water feed pipe Pb2 to the printing machine 7 to be used for predetermined printing and is then collected by the recovery pipe Pb3 and filtrated through the filter 8, before being returned by the recovery pipe Pb4 to the circulation tank 1 as return water.

The dampening water MW refluxed to the circulation tank 1 is fed through the circulation pipe system Pa(1) again to the water feed pump 2(1), the photocatalytic device 3(1), the flowmeter 4(1), the magnetic treatment device 5(1) and the circulation tank 1. The circulation process in which the water is pumped by the water feed pump 6 through the water feeding pipe Pb1, used for printing by the printing machine 7, recovered by the recovery pipe Pb3, filtrated by the filter 8 and then refluxed to the circulation tank 1 is continuously repeated while the printing machine 7 is operating. Since the dampening water is consumed in the printing machine 7, the amount of water consumed must be made up for.

Operations of the water treatment systems for supplying dampening water for wet offset printing according to the second and third best modes are basically the same as the operation of the first best mode.

Prints

Using, as dampening water, water photocatalytically and magnetically treated by the water treatment system for supplying dampening water according to the best modes, wet offset printing may be performed only with ordinary tap water with no addition of IPA or etch solutions. Consequently, prints made using such a system also have characteristics.

For example, since no chemicals such as IPA and etch solutions are added, their residual amounts are null. In addition, since no etch solutions are added, calcium carbonate coated on the surface of printing papers scarcely dissolve, giving such characteristics that whiteness of the surface of prints improves, brightness of the surface of prints increases, and so on. Specifically, brightness of the surface of prints is around 59 when IPA and an etch solution are added and around 64 when the water treatment system according to the invention is used, as implemented under the conditions in Example to be subsequently referred to. For measurement, IG-310 manufactured by HORIBA, Ltd. is used. Further, since no IPA is added, excessive emulsification of dampening water and ink is unlikely to occur, reducing dot gain (gain in thickness of a halftone dot). Dot gains are preferably from 2 to 5%. The dot gains are computed from the following equation. For measurement, SpectroPlate manufactured by TECHKON Co., Ltd. is used.

[dot gain]=[% of halftone dot on print]−[% of halftone dot on printing plate]

### Examples

### Example 1

Water was treated using the water treatment system for supplying dampening water S2 as shown in FIG. 2 and the surface tension of the water was measured. Further, printing was performed using the wet offset printing system M2 as shown in FIG. 2 to evaluate the printability of the print. The circulation tank 1 used had a capacity of 300 L, to which 240 L of tap water was supplied with no isopropyl alcohol, etch solutions or their alternatives and the water treatment system for supplying dampening water was operated for 10 minutes for warm-up before performing the printing. Conditions for experiment (including conditions for printing) are shown below.

Printing Conditions in Actual Use

Printing machine: Offset printing machine (Komori Corporation)

Print speed: 8000 rpm

Printing ink: Oil ink (Fusion-G, Dainippon Ink and Chemicals, Incorporated)

Water: Tap water (at 11° C.)

Printing paper: Coated paper (93.5 kg, Kiku broadsheet)

Test duration: 3 H

Number of colors in print: 4

Environmental conditions: Temperature 25° C., humidity 50 to 60%

Magnetic treatment device: Aqua Correct™ AC-20, Nielsen Technical Trading

Photocatalytic device: UPM-25440-80P, Ube Industries, Ltd.

Water flow rate: 32 L/min

As a result, the evaluation of printability was superior to the conventional evaluation of printability. The results of evaluation are shown in Table 1. Also, print evaluation results when isopropyl alcohol and an etch solution were added without using the water treatment system are also shown.

TABLE 1
80% of halftone dots on printing plate measured, ±2%

| | | IPA + etch | present |
|---|---|---|---|
| | | solution | system |
| black print | 1 | 81.3% | 75.9% |
| | 2 | 82.1% | 76.8% |
| | 3 | 82.8% | 78.2% |
| cyan print | 1 | 91.4% | 78.5% |
| | 2 | 90.7% | 78.6% |
| | 3 | 91.2% | 78.2% |
| magenta print | 1 | 84.5% | 78.8% |
| | 2 | 86.2% | 77.7% |
| | 3 | 85.6% | 79.1% |
| yellow print | 1 | 93.9% | 78.8% |
| | 2 | 93.2% | 79.8% |
| | 3 | 94.7% | 79.6% |

### Example 2

Under the same conditions as those for Example 1 except that the amount of water in the circulation tank 1 was 60 L, water was treated for three hours using the water treatment system for supplying dampening water S2 as shown in FIG. 2 and the surface tension of the water was measured. When the system according to the present invention was operated, the static surface tension of the water in the circulation tank 1 was reduced. Five days after the treatment, the surface tension of the treated water was measured. The surface tension was measured on the basis of the plate method (ISO 304). Conditions for measurement are shown below.

Conditions for Measurement

Measurement method: Plate method

Measurement range: 0 to 100.0 mN/m

Measurement accuracy: ±0.2 mN/m

Measurement reading: 0.1 mN/m

Calibration: manual

Measurement temperature: 24.0±0.5° C.

Humidity: 30%

(Measurement was made in a room at a constant temperature and constant humidity.)

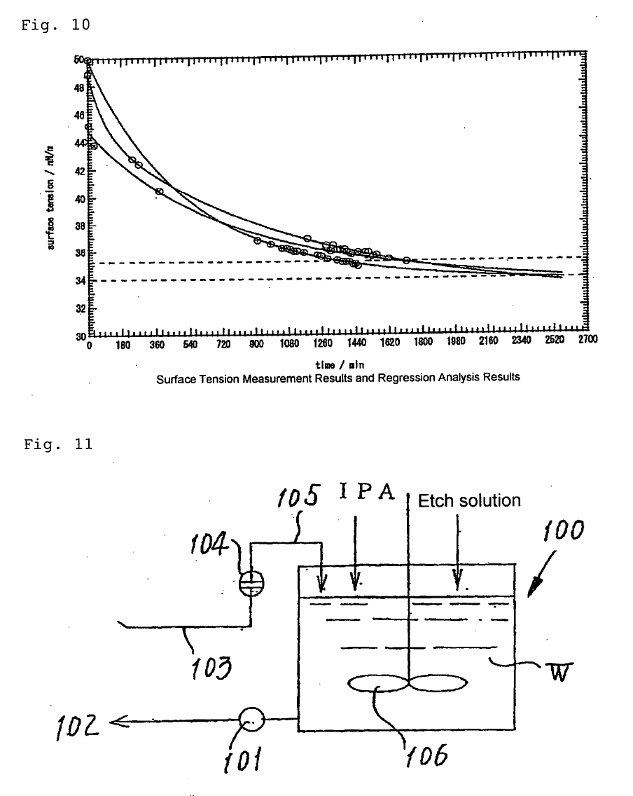

The results of the surface tension measurement showed surface tensions of 34.0 to 35.2 mN/m. Detailed results are shown in Table 2 and FIG. 10.

TABLE 2

| | | |
|---|---|---|
| 1 | 2 | 3 |

| Time | ST | Time | ST | Time | ST |
|---|---|---|---|---|---|
| (min) | (mN/m) | (min) | (mN/m) | (min) | (mN/m) |
| 0 | 48.7 | 0 | 48.9 | 0 | 49.9 |
| 240 | 42.3 | 235 | 42.8 | 906 | 36.8 |
| 1242 | 36.1 | 269 | 42.4 | 983 | 36.5 |
| 1265 | 36.1 | 1179 | 36.9 | 1041 | 36.2 |
| 1289 | 35.9 | 1281 | 36.4 | 1067 | 36.2 |
| 1372 | 35.7 | 1317 | 36.4 | 1086 | 36.1 |
| 1446 | 35.5 | 1354 | 36.1 | 1106 | 36.0 |
| 1464 | 35.4 | 1378 | 36.1 | 1121 | 36.0 |
| 1480 | 35.4 | 1450 | 35.9 | 1161 | 35.9 |
| 1551 | 35.2 | 1490 | 35.9 | 1235 | 35.7 |
| 1582 | 35.1 | 1506 | 35.9 | 1255 | 35.6 |
| 1613 | 34.9 | 1533 | 35.6 | 1289 | 35.4 |
| 1640 | 34.8 | 1551 | 35.7 | 1340 | 35.3 |
| 1662 | 34.6 | 1615 | 35.4 | 1365 | 35.2 |
| | | 1710 | 35.2 | 1388 | 35.2 |
| | | | | 1404 | 35.2 |
| | | | | 1423 | 35.0 |
| | | | | 1438 | 35.0 |
| | | | | 1450 | 34.9 |

1. A water treatment system for supplying dampening water for wet offset printing, comprising:
a flow path through which water can pass;
a magnetic treatment device for magnetically treating the water passing through the flow path; and
a photocatalytic device for photocatalytically treating the water passing through the flow path.

2. The water treatment system according to claim 1, wherein the flow path comprises a circuit configured to introduce water from a circulation tank of a wet offset printing system and to return the introduced water into the circulation tank.

3. The water treatment system according to claim 1, comprising two of the magnetic treatment devices disposed, respectively, before and behind the photocatalytic device.

4. The water treatment system according to claim 1, wherein the photocatalytic device comprises at least one fiber formed body comprised of fibers containing a photocatalyst and an irradiation lamp for irradiating the fiber formed body with light.

5. The water treatment system according to claim 4, wherein the photocatalytic device comprises a plurality of the fiber formed bodies, the fiber formed bodies being mutually isolated in a stacked arrangement along the flow path.

6. The water treatment system according claim 1, further comprising a gas-water separator for separating gases from the water passing through the flow path.

7. A wet offset printing system comprising the water treatment system according claim 1.

8. A method for wet offset printing, comprising a dampening step for supplying dampening water to a printing plate, an inking step for extracting ink from an ink supply section and supplying the ink to the printing plate, a step for transferring the ink deposited on the printing plate to a blanket and a step for transferring the transferred ink from the blanket to a paper,
wherein magnetically and photocatalytically treated water, containing no isopropyl alcohol or etch solutions, is used as the dampening water.

9. The method for printing according to claim 8, comprising the step of obtaining the dampening water from a water treatment system comprising a flow path through which water can pass, a magnetic treatment device for magnetically treating the water passing through the flow path, and a photocatalytic device for photocatalytically treating the water passing through the flow path.

10. A print printed onto a paper surface by wet offset printing, wherein ink on the print and the paper surface contains no isopropyl alcohol or etch solution-derived components and wherein the dot gain of the ink on the print is from 2 to 5%.

11. The print according to claim 10, wherein the differences in dot gain of halftone dots formed by cyan, magenta, yellow and black inks are from 0 to 3%.

12. A print printed onto a paper surface by the wet offset printing method of claims 8, wherein ink on the print and the paper surface contain no isopropyl alcohol or etch solution-derived components.
